(19) United States
(12) Patent Application Publication
(10) Pub. No.: US 2002/0111963 A1
(43) Pub. Date: Aug. 15, 2002

(54) Method, system, and program for preprocessing a document to render on an output device

(75) Inventors: Steven Mark Gebert, Boulder, CO (US); David George Greenwood, Lafayette, CO (US); Reinhard Heinrich Hohensee, Boulder, CO (US); Harry Reese Lewis JR., Longmont, CO (US); Dwight Ross Palmer, Longmont, CO (US); Arthur Ray Roberts, Boulder, CO (US); David Earl Stone, Longmont, CO (US)

Correspondence Address: KONRAD RAYNES VICTOR & MANN, LLP, 315 SOUTH BEVERLY DRIVE, SUITE 210, BEVERLY HILLS, CA, 90212, US

(73) Assignee: International Business Machines Corporation

(21) Appl. No.: 09/782,850

(22) Filed: Feb. 14, 2001

(51) Int. Cl. G06F 15/00; G06F 17/00; G06F 17/21; G06F 17/24

(52) U.S. Cl. 707/513; 707/517; 707/525

(57) ABSTRACT

Provided is a method, program and system for processing a source document in a structured document format including elements providing content to render. A source document and page layout data structure providing formatting properties specifying a layout and format of the content output are received. The source document and the page layout data structure are processed to determine page divisions and formatting properties for the content in the source document. Multiple page objects are generated, wherein each page object includes content and formatting properties for at least one page. The page objects are transmitted to a rasterizer to transform into renderable information capable of being generated by an output device.

### BACKGROUND OF THE INVENTION

1. Field of the Invention

The present invention relates to a method, system, and program for Preprocessing a document for rendering on an output device.

2. Description of the Related Art

Many documents and data objects are encoded in the Extensible Mark-up Language (XML) as structured documents. Numerous categories of data can be encoded within an XML structured document, such as vector graphics, e-commerce transactions, mathematical equations, object meta-data, server APIs, and a thousand other kinds of structured information. XML documents include tags to mark a start and end of each of the logical parts (called elements) of the document. For instance, if the XML document defines a book, the elements would include the table of contents, chapters, paragraphs, appendices, etc. Each element may include content and one or more attributes. An XML document further includes a definition of each element in a formal model, known as a Document Type Definition (DTD). The DTD provides attributes for each element and indicates the relationship of the elements and possible attribute values. Elements may be arranged in a hierarchical relationship. In such case, the DTD would define the hierarchical relationship of the elements to one another. Further details of XML are described in the publication “Extensible Markup Language (XML) 1.0”, Second Edition (Copyright W3C, Oct. 6, 2000), which publication is incorporated herein by reference in its entirety.

The content of an XML document may be printed using the Extensible Style Language (XSL). XSL includes both a transformation language and a formatting language. An XSL stylesheet processor accepts a document or data in XML and an XSL stylesheet and produces the presentation of that XML source content that was intended by the designer of that stylesheet. There are two aspects of this presentation process: first, constructing a result tree from the XML source tree and second, interpreting the result tree to produce formatted results suitable for presentation on a display, on paper, in speech, or onto other media. The first aspect is called tree transformation and the second is called formatting.

Both the source tree and result tree may be expressed as a Document Object Model tree of nodes for the elements of the XML source document. Tree transformation allows the structure of the result tree to be significantly different from the structure of the source tree. For example, one could add a table-of-contents as a filtered selection of an original source document, or one could rearrange source data into a sorted tabular presentation. In constructing the result tree, the tree transformation process also adds the information necessary to format that result tree for presentation. Formatting is enabled by including formatting semantics in the result tree. Formatting semantics are expressed in terms of a catalog of classes of formatting objects. The nodes of the result tree are formatting objects. The classes of formatting objects denote typographic abstractions such as page, paragraph, table, font, margins, etc. Finer control over the presentation of these abstractions is provided by a set of formatting properties, such as those controlling indents, word- and letter-spacing, and widow, orphan, and hyphenation control. In XSL, the classes of formatting objects and formatting properties comprise a presentation language for expressing presentation intent.

The output of the XSL transformation may comprise an HTML document to render within a web browser program, e.g., Microsoft Internet Explorer, Netscape Communicator, etc., or text, graphics or image output for rendering on a printer device. Current techniques exist for transforming an XML document to output that can be transformed or rasterized, such as a page description language (PDL), e.g., PostScript, Portable Document Format (PDF), etc.** To transform the XML document, the entire source file must be rendered in memory and then transformed to a result tree including formatting objects that define an internal representation of the page layouts. Details of formatting such as page size, element size, font, color, margin, page dimensions, etc., are specified by properties. Formatting properties are represented as attributes on the individual formatting object elements. A special XSL application, referred to as an XSL-FO (XSL-Formatting Objects) application, generates from the source XML document a result XML tree including formatting objects to define the page layout for presentation to a reader. **PostScript is a registered trademark of Adobe Systems, Inc.; IPDS and MO:DCA are trademarks of International Business Machines Corporation.

In the prior art, there are application programs that convert an XML-FO document into a viewable format such as PDF or TeX. For instance, the Apache XML Project provides a Java application, known as “FOP”, that reads an XML formatting object tree and then turns it into a PDF document. The Java application must use an XML parser, such as the Simple API for XML (SAX), to parse the XML-FO result tree and then transform the tree elements into output in a PDL format, such as PDF or PostScript. Alternatively, the Result document including formatting objects can be passed into memory as a DOM document. In such case, the Java application would use DOM commands to access the elements of the result tree in the DOM document.

Other prior art techniques for outputting the text into a PDL format involves first transforming the result XML document into a output in a TeX format, which may then be transformed into PostScript or PDF.

With such prior art methods, the generated PDL output is device dependent and optimized for rendering on a specific printer device. One drawback with device dependent output is that it does not produce optimal results when rendered on other devices or rendered on the specific device at a later time. To provide optimal output, the output device would have to itself transform the entire XML document in memory to a result document, then transform the result document into a printer transformable output, such as a page description language (PDL), and then finally rasterized into printer ready output. Such prior art XSL techniques for transforming the XML document require substantial processor and memory resources to render both the source document, result document, PDL data stream, and rasterized data

For these reasons, there is a need in the art for improved techniques for transforming XML documents into output for a printer.

### SUMMARY OF THE PREFERRED EMBODIMENTS

Provided is a method, program and system for processing a source document in a document format including elements providing content to render. A source document and page layout data structure providing formatting properties specifying a layout and format of the content output are received. The source document and the page layout data structure are processed to determine page divisions and formatting properties for the content in the source document. Multiple page objects are generated, wherein each page object includes content and formatting properties for at least one page. The page objects are transmitted to a rasterizer to transform into renderable information capable of being generated by an output device.

In further implementations, the source document includes content in a first presentation language. The source document is transformed into a result document in a second presentation language. The result document includes the content from the source document and the formatting properties provided by the page layout data structure. The formatting properties indicate page divisions of the content. The multiple page objects are generated from the result document.

Still further, the first presentation language may comprise the Extensible Markup Language (XML), the second presentation language comprises the Extensible Stylesheet Language Formatting Objects (XSL-FO), and the page layout data structure comprises an XSL stylesheet.

Additionally, the page objects may include content and formatting properties in a device independent presentation language.

The described implementations provide a technique of preprocessing a source document that relieves the output device that renders the source document into renderable information from processing burdens by performing a substantial amount of the preprocessing prior to rendering at the output device. In certain implementations, the source document is transformed to page objects in a device independent format that provides for optimal rendering at the output device that may be rendered by the output device on a page-by-page basis without having to transform the entire source document.

### BRIEF DESCRIPTION OF THE DRAWINGS

Referring now to the drawings in which like reference numbers represent corresponding parts throughout:

FIG. 1 is an illustration of an implementation of a computing environment in which certain of the described implementations are embodied;

FIG. 2 illustrates an arrangement of a document including Extensible Stylesheet Language Formatting Objects (XSL-FO); and

FIG. 3 illustrates logic to preprocess source documents in accordance with certain implementations.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

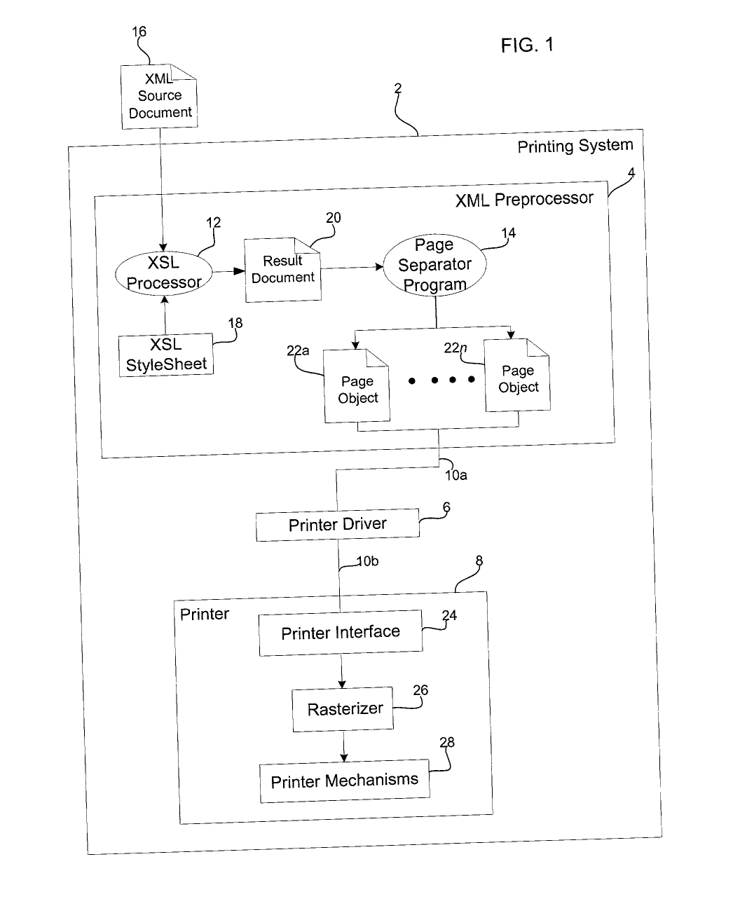

FIG. 1 illustrates a computing environment in which the invention may be implemented. A printing system 2 includes an XML preprocessor 4, a printer driver 6, and a printer 8. The printing system 2 includes one or more computer systems in which the XML preprocessor 4 and printer driver 6 programs are executed. For instance, the XML preprocessor 4 and printer driver 6 may be located on the same computer system, such as a printer server that provides data to the printer 8 over a network to render. Alternatively, the XML preprocessor 4 and the printer driver 6 may execute on separate computers that communicate over a network. The printing system 2 includes communication interfaces 10a, b to provide communication between the XML preprocessor 4, printer driver 6, and printer 8. If the XML preprocessor 4, printer driver 6, and printer 8 are implemented in separate computing devices in a network, then the communication interfaces 10a, b would comprise network interfaces to a network, such as a Local Area Network (LAN), Intranet, the Internet, etc. Alternatively, if the XML preprocessor 4 and printer driver 6 are implemented within the same computer device, then the communication interface 10a, may comprise a bus interface within a computer device. Similarly, if the printer driver 6 and printer 8 are implemented on the same computer device, then the communication interface 10a, may comprise a bus interface within a computer device or output device, such as a printer. Additionally, if the preprocessor 4, printer driver 6, and printer 8 are implemented on the same computer device, then the communication interfaces 10a, b may comprise one or more bus interfaces within the same computer device, such as a printer with significant computational capabilities.

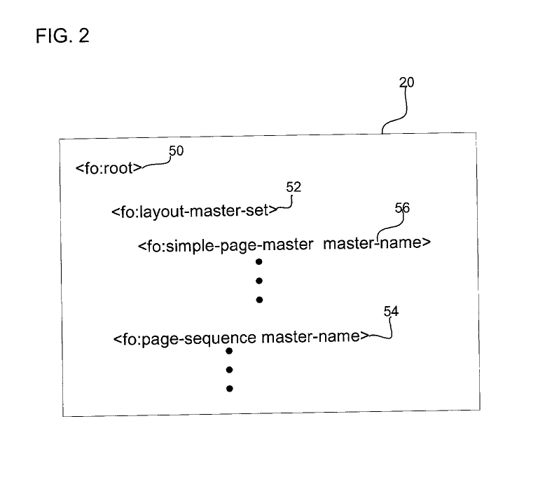

The XML preprocessor 4 includes an XSL processor 12 program and a page separator program 14. The XSL processor 12 is capable of receiving as input a source document 16 in the XML presentation language and an XSL style sheet 18 and transform the XML source document 16 to an Result document 20 including XSL formatting objects (XSL-FO) in a manner known in the art. FIG. 2 illustrates certain of the formatting object components that may be included in the Result document 20. The formatting objects include formatting properties. The term “formatting properties” as used herein describes any information used to express the layout and presentation of the accompanying content, such as page layout, fonts, page size, element size, color, margins, headers, static information, page numbering, indents, word-and letter-spacing, widow and orphan setting, hyphenation and any other format feature known in the art used to define the appearance of a page of content.

As shown in FIG. 2, the result document 20 includes a root element 50, which declares the namespace and function as the root of the document 20. The root element 50 includes one layout-master-set element 52 and one or more page sequence elements 54. The page-sequence elements 54 contain content, such as text and images to place on the pages. The page-sequence element may contain text for one or more pages as defined according to the specified simple-page master element defining the layout of output on the pages. The layout-master-set 52 includes one or more templates, referred to as simple-page-masters 56, that contains templates for the pages that will be created. The page-sequence element 54 specifies the name of a template, or simple-page master 56, to use to provide the layout of the content on the page. Each simple-page master 56 defines a general layout for a page including its margins, the sizes of the header, footer, and body area of the page, etc. Each actual page in the rendered document is based on the content and simple-page-master specified in the page-sequence elements 54. Further details of XSL formatting objects are described in the publication entitled “XML Bible”, at Chapter 15, by Elliote Rusty Harold (Copyright 1999), which publication is incorporated herein by reference in its entirety.

The page separator program 14 receives as input the Result document 20 including the XSL formatting objects and generates one or more page objects 22a . . . n including the content and layout information for each page in the Result document 20. In implementations where the Result document 20 includes the content and formatting properties using the XSL formatting object presentation language, each page object 22a . . . n would include the content and layout specified for each page-sequence element 54 in the Result document 20. As mentioned, the formatting properties for a page are provided in the simple-page master specified in the page-sequence element. Further, the content included in the page object 22a . . . n includes the coding in the language of the original source document 16 that is used to render the content output, such as XML code, PostScript commands, ASCII text, JPEG file, etc. Later, the content in the page object 22a . . . n is transformed to output that the printer or some other device rasterizes to produce output.

In certain implementations, the page separator program 14 may create a page object 22a . . . n in a presentation language that describes the formatting properties and content that is different from XML or XSL formatting objects. A presentation language provides constructs to use to specify the formatting properties to present the content. The document described with the presentation language can be interchanged with different application programs and output devices such that the presentation document produces the same document content in the same format on different printers or display devices dependent, however, on the capabilities of each of the printers or display devices.

For instance, the page separator program 14 may transform the result document 20 including XSL formatting objects into page objects 22a . . . n in a presentation language that conforms to the International Business Machine Corporation's (IBM) Mixed Object Document Content Architecture (MO:DCA), which is described in the publication entitled “MO:DCA Reference”, IBM document no. SC31-6802-04 (IBM Copyright, 1997), which IBM publication is incorporated herein by reference in its entirety.** In the MO:DCA specification, some of the formatting properties for the object are included in environment information that provides information on the logical page, including measurement units, page width, page depth, and page resource requirements. In MO:DCA implementations, each page object 22a . . . n would comprise one MO:DCA page. The page layout and formatting provided in the simple-page master XSL formatting object for the page may be encoded into an active environment group in the MO:DCA page object 22a . . . n. In this way, the formatting specifications of a simple-page-master in the XSL formatting object language are mapped or transformed into the MO:DCA environment groups of a page object 22a . . . n. In certain implementations, certain of the layout and formatting information may not map to the active environment group. That layout and formatting information not mapped to the active environment group may be included in the page content, such as the XML code. **PostScript is a registered trademark of Adobe Systems, Inc.; IPDS and MO:DCA are trademarks of International Business Machines Corporation.

The generated page objects 22a . . . n, including the formatting properties specified in the XSL stylesheet 18 used to produce the Result document 20 and content in the original XML source document 16 code, are then provided to the printer driver 6. The printer driver 6 is a software component that uses a print communication protocol to manage the transfer of pages to a printer interface 24 in the printer 8, and provides for error recovery and other page transfer management operations in a manner known in the art. For instance, the printer driver 6 may utilize the the IBM Intelligent Printer Data Stream (IPDS) printer service that converts a data stream to an IPDS compatible format.** This IPDS data stream is then sent to the printer interface 24 to rasterize and output. The IPDS architecture provides specific commands and status requests. The printer driver 6 may use the IPDS commands to control how the printer 8 processes and rasterizes the page objects 22a . . . n and monitors printer operations. The IPDS architecture defines bidirectional command protocols for query, resource management, and error recovery. Details of the IPDS architecture and acknowledgment protocol are described in the IBM publication “Intelligent Printer Data Stream Reference”, IBM document no. S544-3417-05 (Copyright IBM, 1996), which publication is incorporated herein by reference in its entirety. **PostScript is a registered trademark of Adobe Systems, Inc.; IPDS and MO:DCA are trademarks of International Business Machines Corporation.

The printer driver 6 communicates the pages to a printer interface 24, which may be implemented as a software program executed by the printer 8 processor that is capable of supporting the printer communication protocol used by the printer driver 6, such as the IPDS printer protocol. The printer interface 24 then calls the rasterizer 26 to transform the content in the page object 22a . . . n into raster data according to formatting information and properties included in the page object 22a . . . n. In other words, the rasterizer 26 transforms the presentation language used to express the page object 22a . . . n into raster data capable of being rendered by the printer mechanisms 28. The rasterizer 26 may be implemented as software executed by a printer 8 processor within printer 8 memory, e.g., RAM. Alternatively, the rasterizer 26 may comprise hardware rasterizers implemented in a dedicated integrated circuit, such as an application specific integrated circuit (ASIC), Field Programmable Gate Array (FPGA), etc. There may be multiple rasterizers 26 to rasterize pages objects 22a . . . n in parallel. The output of the rasterizer 26 is sent to a printer mechanism 28, which includes the rollers as well as ink dispenser, e.g., laser jet, ink jet, etc.

FIG. 3 illustrates logic implemented in the XML pre-processor 4 to process an XML source document 16 and generate the page objects 22a . . . n. Control begins at block 100 with the XML preprocessor 4 receiving an XML source document 16. The XSL processor 12 is called (at block 102) and provided the XSL stylesheet 18 specified for the XML source document 16. The XSL processor 12 transforms the XML code in the source document 16 into the result document 20 XML source content and XSL formatting objects (XSL-FO) according to the page layout and formatting properties specified in the XSL stylesheet in a manner known in the art. The XML preprocessor 4 receives the result document 20 outputted from the XSL processor 12 and calls (at block 106) the page separator program 14 to generate the page objects 22a . . . n from the Result document 20. The page separator program 14 would include a parser to process and read the XSL formatting object statements in the result document 20. Blocks 108-130 illustrate operations implemented in the page separator program 14 to transform the result document 20 into page objects 22a . . . n.

At block 108, the page separator program 14 receives the result document 20. For each page-sequence element i in the result document 20, the page separator program 14 accesses (at block 112) the first content element in the page sequence element i. The page separator program 14 further processes (at block 114) the simple-page master element specified in the page sequence element i to determine the formatting properties for the page. The formatting properties included in the simple-page-master are then mapped into the page object 22a . . . n being constructed. For instance, in implementations where the page object 22a . . . n is expressed in the MO:DCA presentation language, some of the formatting properties included in the simple-page-master, which is expressed in the XSL-FO presentation language, are mapped to environment groups in the page object that contain formatting information for the page. In such MO:DCA implementations, the page separator program 14 would include code to transform XSL formatting properties in the simple-page master to formatting properties in the MO:DCA language. A new page object is created (at block 116) and the determined page layout is mapped (at block 118) into page layout constructs in the page object. The page separator program 14 inserts (at block 120) the accessed content element into the page object.

If (at block 122) there is another content element in page-sequence element i, then the next content element in page-sequence element i is accessed (at block 124). If (at block 126) there is room in the page object for the accessed next content element, then control returns to block 120 to insert the accessed content element into the page object. Otherwise, if the page object does not include enough space for the next content element, the page separator program 14 outputs (at block 128) the page object and proceeds back to block 116 to create another page object for the further content element(s) in page sequence element i. If (at block 122) there is not another content element in page-sequence element i, then control proceeds (at block 130) to return to block 110 to process the next page-sequence element i, if there are further page sequence elements.

The outputted page objects 22a . . . n may be stored or archived for later printing. To print the page objects 22a . . . n, the page objects 22a . . . n for an XML source document 16 are sent to the printer driver 6 to, in turn, send to the printer interface 24 in the printer 8. The printer interface 24 would call the rasterizer 26 to transform the page objects 22a . . . n into printer ready raster data that can be rendered by the printer mechanisms 28.

In certain implementations, the page separator program 14 may completely transform the XSL formatted objects in the result document 20 into a data stream conforming to a standard architecture used by applications to describe documents and object envelopes for interchange with other applications and application services, such as the MO:DCA architecture. In alternative implementations, the page objects 22a . . . n may be expressed in other presentation languages, including page description language (PDL) presentation languages, e.g., PDF, PostScript, etc. Page objects in a standard presentation document format may be rasterized by standard transforms known in the art.

In the described implementations, the page separator program 14 may segregate the result document 20 into page objects 22a . . . n that include XSL-FO presentation language statements. In such case, the rasterizer 26 in the printer 8 would include a parser and code to transform the XSL formatted objects in the page objects 22a . . . n into print ready raster data. Additionally, the printer rasterizer 26 may convert the XSL formatted objects in the page objects 22a . . . n into a device independent page description language (PDL) data stream and then perform a further transform from the PDL data stream to printer ready raster data in a manner known in the art.

In the above described implementations, the page objects 22a . . . n include the page content in a device independent presentation language, such as PostScript, PDF, XML formatted objects, etc. This allows the page objects 22a . . . n to be stored or archived and then later rendered on different output devices in a manner that provides optimal output as the particular device rasterizes the page objects 22a . . . n according to its device specific rasterizer. Moreover, the described implementations improve the processing speed of the XML source document 16 because the XML preprocessor 4 performs a substantial amount of the transformation operations up front in the page objects 22a . . . n. In this way, the XML preprocessor 4 relieves the printer 8 of substantial processing burdens during the rasterizing process. Still further, by dividing the result document 20 into multiple page objects 22a . . . n, the printer driver 6 may use print facility services known in the art, such as IPDS services, to manage the transfer of the page objects 22a . . . n to the printer interface 24. Yet further, the printer 8 may rasterize and output the page objects 22a . . . n for an XML source document 16 on a page-by-page basis, instead of having to render and transform the entire XML source document 16 in memory before sending to the output device to render.

Following are some further implementations.

The XML pre-processor 4, printer driver 6, printer interface 24, and rasterizer 26, and any other computational components, may be implemented as a method, apparatus or program using standard programming and/or engineering techniques to produce software, firmware, hardware, or any combination thereof. The program, code and instructions in which the preferred embodiments are implemented are accessible from and embedded in an information bearing medium, which may comprise one or more computer-readable devices, firmware, programmable logic, memory devices (e.g., EEPROMs, ROMs, PROMs, RAMs, SRAMs, etc.), hardware, electronic devices, a computer readable non-volatile storage unit (e.g., CD-ROM, floppy disk, hard disk drive, etc.), a file server providing access to the programs via a network transmission line, wireless transmission media, signals propagating through space, radio waves, infrared signals, etc. Of course, those skilled in the art will recognize that many modifications may be made to this configuration without departing from the scope of the present invention.

In described implementations, the rasterized data is sent to a printer mechanism 28 to generate print output. However, in alternative embodiments the raster objects may provide output data for another device, such as a display monitor, a storage device for future rendering, etc.

In described implementations, the printer driver 6 sends pages of data to the printer 8. In alternative embodiments, other units of data may be sent, such as objects, chapters, commands, etc., instead of pages.

In described implementations, the printer driver and printer interface are located on separate machines. In alternative embodiments, the printer driver and printer interface may be located on the same machine.

In the described implementations, the format and layout of the content of the page was provided to the XSL processor through an XSL stylesheet. In alternative implementations, the source document may be transformed without using an external stylesheet to provide layout information. For instance, the elements within the source document may include internal layout information.

Each processing component, such as the XSL processor 12, page separator program 14, printer driver 6, printer interface 24, and rasterizer 26 may execute on one or more computer systems. Multiple processing components may be implemented on the same computer system or distributed across multiple computer systems.

In the described implementations, the XML source document was in XML and the transformed result document included XSL formatting objects. In additional implementations, the source document and result document may be expressed in a different presentation language other than XML or XSL formatting objects. For instance, the source document presentation language may comprise another structured document language, such as Dynamic Hypertext Mark-Up Language (DHTML), the Extensible Markup Language (XML), Cascading Style Sheets, any other Standard Generalized Markup Language (SGML), or any other language known in the art for creating interchangeable, structured documents. In yet further embodiments, the requested file may be in any other file format, i.e., other than an SGML type format, capable of being displayed or otherwise executed by the requesting client. Still further, the source document may be written in a page description language, such as PostScript, PDF, etc., wherein the individual page object would include content in the page description language to print on separate pages.

In the described implementations, the page objects 22a . . . n utilize a device independent presentation language describing the formatting properties that is rasterized by the printer 8 before printing. In alternative implementations, the page objects 22a . . . n may be rasterized before transmission to the printer 8 or other output device. Such implementations would further relieve the printer 8 of processing burdens.

The program flow logic described in the flowcharts indicated certain events occurring in a certain order. Those skilled in the art will recognize that the ordering of certain programming steps or program flow may be modified without affecting the overall operation performed by the preferred embodiment logic, and such modifications are in accordance with the preferred embodiments.

In the described implementations, the elements in the documents as arranged in a hierarchical fashion. However, in alternative embodiments, the elements do not have to be in a hierarchical relationship to one another.

In the described implementations, each page object 22a . . . n included information to render one page of output. In alternative printing environment implementations, each page object 22a . . . n may include content and formatting information to render multiple pages of output.

The XML source document 16 may maintain instances of any type of data object that can be expressed as a structured document, such as print jobs, newspaper articles, Internet Web pages, books, etc.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for processing a source document in a structured document format including elements providing source content to render, wherein the source content comprises code that is rasterized into output, comprising:
receiving the source document;
receiving a layout data structure providing formatting properties specifying a layout and format of the content output;
processing the source document and the layout data structure to determine formatting properties, including page divisions, for the content in the source document;
generating multiple page objects, wherein each page object includes source content and formatting properties for one page; and
transmitting the page objects to a rasterizer to transform into renderable information capable of being generated by an output device.

2. The method of claim 1, wherein the source document includes statements in a first presentation language, further comprising:
transforming the source document and source content therein into a result document in a second presentation language, wherein the result document includes the source content and the formatting properties provided by the layout data structure, wherein the formatting properties indicate page divisions of the content, and wherein the multiple page objects are generated from the result document.

3. The method of claim 2, wherein the layout data structure comprises a separate document from the source document.

4. The method of claim 2, wherein the first presentation language comprises the Extensible Markup Language (XML) and wherein the second presentation language comprises Extensible Stylesheet Language Formatting Objects (XSL-FO), and wherein the page layout data structure comprises an XSL stylesheet.

5. The method of claim 2, wherein the page objects include formatting properties in a third presentation language.

6. The method of claim 5, wherein the first presentation language comprises the Extensible Markup Language (XML), wherein the second presentation language comprises Extensible Stylesheet Language Formatting Objects (XSL-FO), wherein the third presentation language comprises the Mixed Object Document Content Architecture (MO:DCA), and wherein the layout data structure comprises an XSL stylesheet.

7. The method of claim 5, wherein the third presentation language comprises a page description language.

8. The method of claim 2, wherein the page objects include content and formatting properties in the second presentation language.

9. The method of claim 2, wherein the second presentation language comprises Extensible Stylesheet Language Formatting Objects (XSL-FO).

10. The method of claim 1, wherein the page objects include content and formatting properties in a device independent presentation language.

11. The method of claim 1, wherein the source content is in a page description language.

12. The method of claim 1, wherein the source document and page objects include the formatting properties in a same presentation language.

13. The method of claim 1, wherein the page object includes content and formatting properties for one page.

14. The method of claim 1, wherein the source document does not indicate page divisions for the content.

15. A system for processing a source document in a structured document format including elements providing source content to render, wherein the source content comprises code that is rasterized into output, comprising:
means for receiving the source document;
means for receiving a layout data structure providing formatting properties specifying a layout and format of the content output;
means for processing the source document and the layout data structure to determine formatting properties, including page divisions, for the content in the source document;
means for generating multiple page objects, wherein each page object includes source content and formatting properties for one page; and
means for transmitting the page objects to a rasterizer to transform into renderable information capable of being generated by an output device.

16. The system of claim 15, wherein the source document includes statements in a first presentation language, further comprising:
means for transforming the source document and source content therein into a result document in a second presentation language, wherein the result document includes the source content and the formatting properties provided by the layout data structure, wherein the formatting properties indicate page divisions of the content, and wherein the multiple page objects are generated from the result document.

17. The system of claim 16, wherein the layout data structure comprises a separate document from the source document.

18. The system of claim 15, wherein the first presentation language comprises the Extensible Markup Language (XML) and wherein the second presentation language comprises Extensible Stylesheet Language Formatting Objects (XSL-FO), and wherein the page layout data structure comprises an XSL stylesheet.

19. The system of claim 15, wherein the page objects include formatting properties in a third presentation language.

20. The system of claim 19, wherein the first presentation language comprises the Extensible Markup Language (XML), wherein the second presentation language comprises Extensible Stylesheet Language Formatting Objects (XSL-FO), wherein the third presentation language comprises the Mixed Object Document Content Architecture (MO:DCA), and wherein the layout data structure comprises an XSL stylesheet.

21. The system of claim 19, wherein the third presentation language comprises a page description language.

22. The system of claim 16, wherein the page objects include content and formatting properties in the second presentation language.

23. The system of claim 16, wherein the second presentation language comprises Extensible Stylesheet Language Formatting Objects (XSL-FO).

25. The system of claim 15, wherein the page objects include content and formatting properties in a device independent presentation language.

26. The system of claim 15, wherein the source content is in a page description language.

27. The system of claim 15, wherein the source document and page objects include the formatting properties in a same presentation language.

28. The system of claim 15, wherein the page object includes content and formatting properties for one page.

29. The system of claim 15, wherein the source document does not indicate page divisions for the content.

30. An article of manufacture for processing a source document in a structured document format including elements providing source content to render, wherein the source content comprises code that is rasterized into output, and wherein the article of manufacture comprises code capable of causing a processor to perform:
receiving the source document;
receiving a layout data structure providing formatting properties specifying a layout and format of the content output;
processing the source document and the layout data structure to determine formatting properties, including page divisions, for the content in the source document;
generating multiple page objects, wherein each page object includes source content and formatting properties for one page; and
transmitting the page objects to a rasterizer to transform into renderable information capable of being generated by an output device.

31. The article of manufacture of claim 30, wherein the source document includes statements in a first presentation language, and wherein the code is further capable of causing the processor to perform:
transforming the source document and source content therein into a result document in a second presentation language, wherein the result document includes the source content and the formatting properties provided by the layout data structure, wherein the formatting properties indicate page divisions of the content, and wherein the multiple page objects are generated from the result document.

32. The article of manufacture of claim 31, wherein the layout data structure comprises a separate document from the source document.

33. The article of manufacture of 31, wherein the first presentation language comprises the Extensible Markup Language (XML) and wherein the second presentation language comprises Extensible Stylesheet Language Formatting Objects (XSL-FO), and wherein the page layout data structure comprises an XSL stylesheet.

34. The article of manufacture of 31, wherein the page objects include formatting properties in a third presentation language.

35. The article of manufacture of 34, wherein the first presentation language comprises the Extensible Markup Language (XML), wherein the second presentation language comprises Extensible Stylesheet Language Formatting Objects (XSL-FO), wherein the third presentation language comprises the Mixed Object Document Content Architecture (MO:DCA), and wherein the layout data structure comprises an XSL stylesheet.

36. The article of manufacture of claim 34, wherein the third presentation language comprises a page description language.

37. The article of manufacture of claim 31, wherein the page objects include content and formatting properties in the second presentation language.

38. The article of manufacture of claim 31, wherein the second presentation language comprises Extensible Stylesheet Language Formatting Objects (XSL-FO).

39. The article of manufacture of claim 31, wherein the page objects include content and formatting properties in a device independent presentation language.

40. The article of manufacture of claim 30, wherein the source content is in a page description language.

41. The article of manufacture of claim 30, wherein the source document and page objects include the formatting properties in a same presentation language.

42. The article of manufacture of claim 30, wherein the page object includes content and formatting properties for one page.

43. The article of manufacture of claim 30, wherein the source document does not indicate page divisions for the content.
